(19) United States
(12) Patent Application Publication
(10) Pub. No.: US 2003/0216867 A1
(43) Pub. Date: Nov. 20, 2003

(54) Methods and systems for molecular modeling

(76) Inventors: Phil G. Campbell, Cranberry Township, PA (US); Alexander P. Cohen, Perry, KS (US); Lauren A. Ernst, Pittsburgh, PA (US); John Ernsthausen, Pittsburgh, PA (US); Daniel L. Farkas, Los Angeles, CA (US); William Galbraith, Pittsburgh, PA (US); Meir Israelowitz, Pittsburgh, PA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/397,956

(22) Filed: Mar. 26, 2003

Related U.S. Application Data
(60) Provisional application No. 60/368,025, filed on Mar. 26, 2002.

(51) Int. Cl. G06F 19/00

(52) U.S. Cl. 702/19

(57) ABSTRACT

The present invention is in part directed molecular modeling. In one aspect, a method for determining a structure of a protein is provided, comprising determining the minimum excluded volume of said protein. In another aspect, a method for identifying molecules is provided. In yet another aspect, a computer product is provided for determining the structure of a protein.

### RELATED APPLICATION INFORMATION

This application claims priority to provisional U.S. Patent Application No. 60/368,025 filed Mar. 26, 2002, which is hereby incorporated by reference in its entirety.

### BACKGROUND

Predicting the conformation of molecules is a problem that has important consequences in a variety of commercially important technical areas. For example, new drug development increasingly relies on the rapid prediction of molecular conformations to identify a few promising candidate compounds. In the area of optical polymers, prediction of the orientation of polymer chains and substituents can facilitate design of an optical device. Knowledge and prediction of polymer conformation may also be important, for example, for tissue engineering and for polymer design directed to controlled drug delivery.

With the onset of the post-genomic era, a significant challenge is to identify the protein products, and their function and structure, of the 30,000 genes of the human genome. This number increases to ˜1.4 million when possible genetic polymorphism products are taken into account. Protein structure may drive protein function, therefore understanding protein structure will be basic to applying the post-genomic revolution to biology and medicine. Acceleration of physical methods to determine protein structure may be hampered by production of sufficient quantities of pure proteins and the idiosyncratic process of X-ray crystallography. With crystallography an inexact science, with estimates of 1 in 20 proteins yielding usable crystals for study, simple scale up in processing may not meet the demand for protein structure data. Thus, there is a need for high quality 3D protein structural and computational proteomic modeling.

Currently there are three commonly used methods that may sample protein conformation spaces: molecular dynamics, Monte Carlo, and Smith's microfibril model. Molecular dynamics considers coordinate positions of the atoms of the amino acids in the sequence. To obtain a minimum, methods based on molecular dynamics calculate a gradient or steep slope. The Monte Carlo method minimizes the molecule from the random coil to the confirmation by obtaining a global minimum. Monte Carlo methods take samples of a configuration space, for example, on a confirmation path. When a path is at a local minimum, it may be difficult to know if a global minimization has been reached. Smith's microfibril model calculates a conformation energy by finding the differences between a random state and a final conformation. The difference between the two states is the objective function.

The limitations of computer modeling include limitations by computational cost. To minimize a molecular structure, for example, many position changes in a confirmation may need to be considered, or in the case of local minimum, many possible energies may need to be considered. Further, computational cost may also limit including further features of a structure, for example, surface interactions.

Other methods of structural data have limitations as well. X-ray crystallography techn iques allow identification of one instant of a structure. Proteins may be in an aqueous environment, and this crystallography, as well as current computational models, may often be unable to consider dynamic behavior in the aqueous environment.

Molecular structures and moieties which may also be difficult to characterize include tissues, surfactants, inorganic and organic small molecules, and self-assembled molecules. Other important molecular structures and constructs may also be difficult to characterize, and a model that allows identification of the structure of such molecules would be highly valuable.

Structure-based drug design is a major activity in pharmaceutical laboratories. In structure-based drug design, the overall goal is to design a small molecule that binds to a specific site in a target molecule, usually a protein or other macromolecule. Where the target protein is an enzyme, the specific target site is often the substrate binding site or active site of the enzyme. Where the target protein is a receptor, the specific target site is often the binding site for a natural ligand of the receptor. In nearly all of the goals is to alter the behavior of the target molecule in a predetermined way as a result of the binding of the small molecule.

### SUMMARY

A disclosed method includes determining a structure of a protein having a known primary structure, where the method includes determining a minimum excluded volume of the protein. In one embodiment, the method includes determining a structure of a protein comprising determining a minimum excluded volume of at least two amino acids in a given protein. In an embodiment, the method further includes selecting one or more angles, such as a dihedral angle of the amino acid, which minimizes the excluded volume of at least one amino acids of the protein.

In an embodiment, a method for determining a structure of protein includes determining a minimum excluded volume of the protein. This method may further include sequentially: i) selecting one of said two amino acids; and ii) determining an angle which minimizes a volume of the selected amino acid. In an embodiment, the method for determining a structure of protein further includes a method wherein (i) and (ii) are performed iteratively. In an embodiment, the method may include an iterative selection which includes selecting an amino acid that is attached to the selected amino acid of the previous iteration. The method may also include determining the minimum excluded volume of both amino acids.

In one embodiment, the method of determining a structure of protein is presented which includes determining a minimum excluded volume of at least two amino acids in the protein, and further includes sequentially i) selecting one of the two amino acids; and ii) determining at least one angle which minimizes a volume of the selected amino acid, wherein at least one of the angles is determined by finding a difference between a distance of a) atoms of the first amino acid and atoms of a distinct second amino acid; and b) a projection onto a plane of atoms of the first amino acid and atoms of the distinct second amino acid.

In one embodiment, the method of determining a structure of protein may comprise finding a minimum excluded volume of at least two amino acids in the protein, where the protein includes a single-chain protein. Additionally and optionally, the method of determining a structure of protein includes determining a minimum excluded volume of at least two amino acids in the protein, where the protein may comprise multiple-chain peptides.

The method of determining a structure of protein may include determining a minimum excluded volume of at least two amino acids in a protein, where further bond angles and bond lengths between the two amino acids are constrained to an equilibrium value.

The method of determining a structure of protein may also include determining a minimum excluded volume of at least two amino acids in a protein, and may include providing distance constraints between hydrogen atoms and oxygen atoms on the two amino acids.

The method of determining a structure of protein may additionally include determining a minimum excluded volume of at least two amino acids in a protein, and further includes minimizing the volume of each amino acid by using an optimization function depending on hydrophicity of said amino acid.

A method for determining a structure of a protein can be described as: i) converting one or more polypeptide sequences into a series of constant arclengths; ii) selecting at least one angle which minimizes the volume around one arclength; iii) selecting at least one angle which minimizes the volume around an arclength associated with the arc length in ii), and iv) iterating ii) and iii) along a polypeptide chain. The arc length may be determined from an atom in one amino acid, to an atom in a distinct second amino acid.

The disclosed methods provide a method for identifying molecules which interact with a target protein, the method including: (a) determining a minimum excluded volume of each amino acid in a target protein; (b) determining a low potential energy of a protein complexed to a small molecule selected from a library of small molecules; (c) repeating the determining to identify the small molecule that provides the lowest free energy of the protein complexed to a small molecule; and selecting the small molecule that provides the lowest free energy. In one embodiment, the target protein is an enzyme. In an embodiment, the target protein is a receptor.

The disclosed methods also include a method for rational drug design, which comprises determining the minimum excluded volume of a receptor site of a protein.

Also disclosed is a computer product for determining the structure of a protein wherein the computer product is disposed on a computer readable medium and includes instructions a causing a processor to minimize the volume of amino acids in a polypeptide chain.

A system is also provided and includes at least one processor and instructions for causing the processor to minimize the volume of amino acids in a polypeptide chain.

### BRIEF DESCRIPTION OF THE DRAWINGS

These and other features and advantages of the methods, and systems disclosed herein will be more fully understood by reference to the following illustrative, non-limiting detailed description in conjunction with the attached drawings in which like reference numerals refer to like elements throughout the different views. The drawings illustrate principals of the methods systems and processes disclosed herein.

FIG. 1 depicts an exemplary peptide showing arclengths from the carbonyl carbon of an amide bond to, but not including, the next peptide bond.

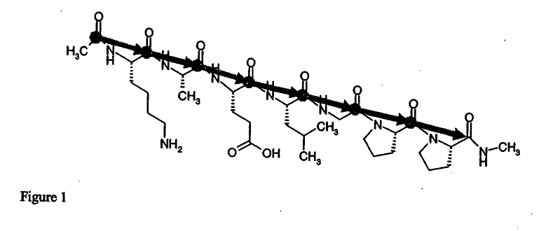

FIG. 2 shows the length between two points may described as segments of arc-length.

FIG. 3 shows the intersection of the closure of two beads.

FIG. 4 depicts the equivalence of two braids.

FIG. 5 depicts the projection of vectors for calculation of the excluded volume.

FIG. 6 shows a plane Q which includes a portrayal of the projection of a vector.

FIG. 7 shows a layer of three beads, shown by the arrows, with a distance from the bead to the spine, after the first bead is locked into position, for an exemplary collagen protein.

FIG. 8 depicts a next layer of beads dependent on the first layer.

FIG. 9 shows the lacing of beads as the backbone of a protein.

FIG. 10 depicts the two bonds that rotate and which may be used to determine the minimum volume.

FIG. 11 shows the projections of the vectors used to calculate the minimum volume.

FIG. 12 shows the sequences of the three strands of a collagen protein.

FIG. 13 is a diagram of a computer platform suitable for executing instructions for determining the structure by minimizing the volume.

FIG. 14 shows the C-H backbone and beads of a Val-Ala-Lys peptide.

FIG. 15 shows a dihedral angle 0 and angle (p for a Val-Ala-Lys peptide.

FIG. 16 shows the standard deviation of the calculated tertiary structure for nine exemplary proteins in comparison with the known tertiary structure from the Protein Data Bank.

FIG. 17 compares the results of the minimization of a 1 BBF protein to the crystal structure from the Protein Data Bank.

FIG. 18 compares the results of the minimization of a 1 CGD protein to the crystal structure from the Protein Data Bank.

FIG. 19 compares the results of the minimization of a IAQ5 protein to the crystal structure from the Protein Data Bank.

FIG. 20 compares the results of the minimization of a 1DEQ protein to the crystal structure from the Protein Data Bank.

FIG. 21 compares the results of the minimization of a IBFO protein to the crystal structure from the Protein Data Bank.

FIG. 22 compares the results of the minimization of a 1 COC protein to the crystal structure from the Protein Data Bank.

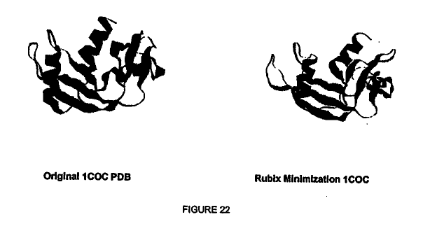

FIG. 23 compares the results of the minimization of a 1 CQD protein to the crystal structure from the Protein Data Bank.

FIG. 24 compares the results of the minimization of a 1AQP protein to the crystal structure from the Protein Data Bank.

### DETAILED DESCRIPTION

1. Overview

In one aspect, this disclosure provides a method for determining the three-dimensional structure of a polymer, such as for example, a protein or polypeptide having a known primary sequence. A given polypeptide may be modeled using the methods provided herein. A given polypeptide may be represented by a low-dimensional topology structure called a “braid group.” A braid group is essentially a “union of arc lengths”, wherein an arc length runs from the carbonyl carbon atom of the amide bond of the first amino acid residue to, but not including the carbon of the next carbonyl of the second residue. In other words, a polypeptide backbone may be considered to be a series of rigid arc lengths carrying various substituents. Specifically, an arc length is the length of a curve over an interval. The arclengths may be obtained for example, from known crystallographic data which includes bond distances between atoms in a protein.

In this method, the length and direction of the arc lengths are kept constant, but each arc length is now expanded to include the remainder of the amino acid residue. This unit or segment forms a “bead”. Accordingly, a bead has a finite volume, which may be occupied by an amino acid residue. The bead shape is generally not spherical, rather it varies in part as a function of the R groups for the particular amino acid, and is based on the interaction between the beads. A bead interacts with at least two other beads by a rotating Coc-C(O) bond. Therefore, a braid representing the polypeptide chain may be thought of as a collection of beads.

The conformation of the peptide is now in part a function of the orientation between pairs of beads. The orientation of a given bead is in part function of a torsional rotation o between the adjacent beads, and the dihedral angles (pi. The method described herein, first finds the optimal angles which minimize the individual volume of a bead using an optimization function. These optimal angles depend on the volume of the beads on either side.

In case of multimeric polypeptides, a chain can be considered to be a strand, for example, collagen may be considered to be a three-stranded braid.

2. Definitions

For convenience, before further description of the present invention, certain terms employed in the specification, examples and appended claims are collected here. These definitions should be read in light of the remainder of the disclosure and understood as by a person of skill in the art. Unless defined otherwise, technical and scientific terms used herein have the same meaning as commonly understood by a person of ordinary skill in the art.

The articles “a” and “an” are used herein to refer to one or to more than one (i.e. at least one) of the grammatical object of the article. By way of example, “an element” means one element or more than one element.

The term “arc length” or “arclength” refers to length of a curve over an interval.

The term “binding” refers to an association between two molecules, due to, for example, covalent, electrostatic, hydrophobic, ionic and/or hydrogen-bond interactions under physiological conditions.

The term ‘bead’ refers to the finite volume around a given segment of a molecule.

The term “braid’ refers to the union of arc lengths forming a string. A braid is a collection of beads.

The terms “compound”, “test compound” and “molecule” are used herein interchangeably and are meant to include, but are not limited to, peptides, nucleic acids, carbohydrates, small organic molecules, natural product extract libraries, and any other molecules (including, but not limited to, chemicals, metals and organometallic compounds)

The term “domain” as used herein refers to a region of a protein that comprises a particular structure and/or performs a particular function.

The term “excluded volume” for a given object is defined as the volume surrounding and including a given segment, which is excluded to another segment. This definition holds in both three dimensional and two-dimensional space. For example, the excluded volume may comprise a bead.

As provided herein, a determination of a minimum and/or minimizing can be understood to be a reference to a mathematical value or other mathematical expression of a function that is less than other values of the function over a specific interval.

The term “minimum excluded volume” is a local and/or global minimum of an excluded volume. The minimum excluded volume may depend on, for example, internal angles, distances, and angles between one excluded volume and another. For example, the minimum excluded volume may be a minimum volume of a bead.

The terms peptides, proteins and polypeptides are used interchangeably herein. Exemplary proteins are identified herein by annotation as such in various public databases.

A “receptor” or “protein having a receptor function” is a protein that interacts with an extracellular ligand or a ligand that is within the cell but in a space that is topologically equivalent to the extracellular space (eg. inside the Golgi, inside the endoplasmic reticulum, inside the nuclear membrane, inside a lysosome or transport vesicle, etc.). Receptors often have membrane domains.

“Small molecule” as used herein, is meant to refer to a composition, which has a molecular weight of less than about 5 kD and often less than about 2.5 kD. Small molecules can be nucleic acids, peptides, polypeptides, peptidomimetics, carbohydrates, lipids or other organic (carbon containing) or inorganic molecules. Many pharmaceutical companies have extensive libraries of chemical and/or biological mixtures comprising arrays of small molecules, often fungal, bacterial, or algal extracts, which can be analyzed for potential binding with the disclosed methods.

3. Algorithm

The present invention relates to methods, systems, and products for determining the structure of a molecule. In one aspect of the invention, a method is provided for determining the structure of a chain of molecules. A chain of molecules may be a molecular structure that comprises one or more molecular units. In addition, the chain of molecules may possess a series of side chains extending from the main chain. Molecular units may be, for example, amino acids, monomers, atoms, molecules, nucleic acids, nanostructures, aggregates, and blocks. A molecular structure, including molecular structures with one or more chains of molecules may be determined by this method, including, for example, proteins, polypeptides, glycoproteins, polysaccharides, antigens, epitopes, enzymes, nucleic acids, RNA, tissue, polymers, colloids, lipids, aggregates, polymer and surfactant systems, micelles, macromolecules, and self-assembled molecules including membranes, vesicles, tubules, and micelles, although such examples are provided for illustration and not limitation.

In an embodiment, a method is provided for determining the structure of a protein, peptide, or polypeptide. Determining the structure of a protein may comprise determining one or more of the primary structure, the secondary structure, the tertiary structure, or the quaternary structure of a protein. In an embodiment, a method is provided for determining the tertiary structure of a protein with a known primary structure, for example the protein sequence.

The primary structure of a protein or polypeptide includes the linear arrangement of amino acid residues along the chain and the locations of covalent bonds. The secondary structure of a protein or polypeptide includes folded chains, for example, α-helices and pleated sheets. A protein may comprise one or more α helical structures, one or more βpleated sheets, globular structures, any secondary structure, or any combination of α helical structures, βpleated sheets, globular structures, or any secondary structure.

A peptide is an oligomer of amino acids attached in a linear sequence to form, for example, a protein or an enzyme. Peptides consist of a main chain backbone having the following general pattern:

H—[—NH—Cα(R)—C(O)]n—OH

where n represents the number of amino acid residues in the peptide and Cα is the so-called alpha carbon of an amino acid. Attached to an alpha carbon is a distinctive side-chain, or R group, that identifies an amino acid.

A protein may comprise one or more folded units, secondary structures, or domains. A protein may comprise one or more domains or motifs. A motif is a regular substructure that occurs in otherwise different domains. The tertiary structure of a protein or polypeptide includes folding of regions between secondary structures, for example between α helices and β pleated sheets, and the combination of these secondary structures into compact shapes or domains. The tertiary structure of a peptide represents the three dimensional structure of the main chain, as well as the side-chain conformations. The quaternary structure includes organization of several polypeptide chains into a single protein molecule.

Non-amino acid fragments are often associated with a peptide. Such fragments can be covalently attached to a portion of the peptide or attached by non-covalent forces (ionic bonds, van der Waals interactions, etc.). For example, many peptides are bound in the cell membrane are used for cell recognition and have carbohydrate moieties attached to one or more amino acid side-chains. Non-amino acid moieties include, but are not limited to, heavy metal atoms such as, for example single molybdenum, iron, or manganese atoms, or clusters of metal atoms, nucleic acid fragments (such as DNA, RNA, etc.), lipids, and other organic and inorganic molecules (such as hemes, cofactors, etc.).

The three-dimensional complexity of a peptide may arise because some bond angles in the peptide can bend and some bonds can rotate. The “conformation” of peptide is a particular three-dimensional arrangement of atoms and, as used herein, is equivalent to its tertiary structure. The large size of a peptide chain, in combination with its large number of degrees of freedom, allows it adopt an immense number of conformations. Despite this, many peptides, even large proteins and enzymes, fold in vivo into well-defined three-dimensional structures. The peptide generally folds back on itself creating numerous simultaneous interactions between different parts of the peptide. These interactions may result in stable three-dimensional structures that provide unique chemical environments and spatial orientations of functional groups that give the peptide its special structural and functional properties, as well as its physical stability.

A chemical structure that comprises a string of molecules, for example a properly folded protein, may be in a minimum potential energy state. Here, the minimum excluded volume of a chain of molecules may be used as a proxy for the free energy of the chain of molecules. In one embodiment, a method is provided for determining the structure of a chain of molecules comprising determining the minimum excluded volume of the molecule by using an arc length model which includes a finite volume occupied by an amino acid or a partial amino acid. In an embodiment, the excluded volume of a chain of molecules may be represented by a low-dimensional topology structure called a braid group. A braid may represent a chain of molecules, for example, a peptide chain, which is a collection of beads, wherein the molecules may be, for example, represented as beads. Conformations of the structure of the chain of molecules may be treated as changes in the relative orientation between pairs of beads. For large, single-chain proteins, for example, this may be a significantly simplified approach to molecular modeling.

In one embodiment, a method is provided for predicting peptide structures, and hence stabilities and functional properties, from knowledge of constituent amino acids. In one embodiment, the initial conformation of the peptide or other molecular representation may be reasonably close to the actual conformation, and therefore considerable computational savings may be realized. In some embodiments, a partial three-dimensional structure of the peptide may be used as a starting point for molecular modeling. For example, the peptide being modeled may have already been synthesized and studied, or it may be closely related to a peptide for which the structure is already known. In either case, some but not all structural information may be available to guide the initial conformation of the representation. Many suitable methods exist that provide this partial information. X-ray or neutron diffraction provides a detailed picture of the three-dimensional positioning of the peptide main chain. Other methods for partially determining the three-dimensional conformation of the peptide suitable for use with the invention include, for example, nuclear magnetic resonance (NMR) spectroscopy and theoretical prediction. Suitable NMR methods include two-dimensional 1H NMR methods (including correlated experiments which rely on J-coupling) which provide interproton relationships using through-bond coupling, and the Nuclear Overhauser Effect (NOE) experiments which provide spatial relationships using through-space.

In one embodiment, the atomic positions and the bond lengths of the molecules or beads are known, for example, from crystallography. In another embodiment, the atomic positions and/or the bond lengths can be computed using algorithms and computer software known to those skilled in the art such as AMBER, CHARMM, and GROMOS.

In one embodiment, the length of the beads may be obtained by an arc length model. In an embodiment, the atomic positions and bond lengths of a chain of molecule or beads is fixed in a particular position and the length or chaining of beads may then be obtained by an arc length model.

In an embodiment, the length or chaining of beads may be obtained by any known method for determining the arrangement of a set of points in a given volume.

The arc-length model may comprise a path, which for example, may be an one-dimensional sub-manifold M of R³, so that for a point x ∈ M there is a local parameterization near^{x}, with C^{k} (k≧2). The curvature of the path and D is denoted by the coordinates identifying the path. The output of an iteration is a set of coordinates in three dimensions, D=(x₁, x_{2, . . . , x}ₙ), identifying a path. A length bond may be denoted as the polygonal arc around the path. The curvature C^{k} and the arc-length are non-regular. Let x=x(t), with a≦t≦b and consider a partition:

a=t₀<t₁<. . . <tₙ=b 1.0

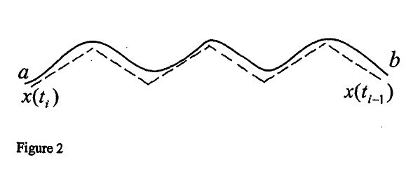

of an interval (a,b). The sequence (a,b) are the boundaries of a single coil) gives an approximation to the polygon arc C. As illustrated in FIG. 2, the length between two points (a,b), where D are segments of arc-length given by:

$$λ ( D ) = {\sum }_{j = 1}^{n} {D}_{j} = {\sum }_{i = 1}^{n} ‖ {x}_{i} - {x}_{i - 1} ‖ = {\sum }_{i = 1}^{n} ‖ x ( {t}_{i} ) - x ( {t}_{i - 1} ) ‖ \qquad 1.1$$

The arc-length may be bounded from above and from below. The upper bound is given by:

$${ρ}_{+} ( K , D ) = \frac{1}{λ ( D )} {\sum }_{( K ∘ {D}_{j} ) ⋂ D \neq ∅}^{} λ ( K ∘ {D}_{j} ) \qquad 1.2$$

And the lower bound may be given by:

$${ρ}_{-} ( K , D ) = \frac{1}{λ ( D )} {\sum }_{( K ∘ {D}_{j} ) ⋐ D}^{} λ ( K ∘ {D}_{j} ) \qquad 1.3$$

where p+(K, D) may be the ratio of the total measure of the set in the system K, (the volume minimization), so that the transformation ° (projection) of the segments and the curve C give a lower and an upper bound of (a,b), where a and b may be defined as:

$$\begin{matrix}b = {ρ}_{+} = {lim}_{λ ( D ) \to ∞} sup {ρ}_{+} ( K , D ) = {lim}_{λ \to ∞} sup {{ρ}_{+}}_{λ ( D ) \geq λ} ( K , D ) & 1.4 \\ a = {ρ}_{-} = {lim}_{λ ( D ) \to ∞} inf {ρ}_{-} ( K , D ) = {lim}_{λ \to ∞} {inf}_{λ ( D ) \geq λ} {ρ}_{-} ( K , D ) & 1.5\end{matrix}$$

Hence the boundaries of C may be given by equations (1.4) and (1.5).

In one embodiment, the peptide bonds of the protein chain form the arc lengths of braids. A peptide chain thus includes of a series of rigid arc lengths carrying various substitute groups. For example, an arc length may run from a carbonyl carbon of the amide bond to, but not including, the next peptide carbonyl carbon. Folding the polypeptide chain into different conformations may result in changing the relative orientation of these arc lengths. Although this grouping does not follow the biosynthetic pattern, it may limit orientation changes to movements about a freely rotating Cα—C(O) bond. Constraints in the standard braid theory prohibit braids from incidental intersection with themselves or other braids act properly in this application to keep the modeled peptide chains, for example, from overlapping each other.

In an embodiment, a chain as a collection of beads forming a braid may be described as the following: D is said to be covering itself if

$${⋃}_{j} {D}_{j} ⊃ D$$

and each element of at least one of D belongs to dⱼ. The system D is to say packing if

$${D}_{i} ⋂ {D}_{j} = ∅ ( i \neq j ) , {⋃}_{i} {D}_{i} ⊃ D$$

If two sets D₁, D₂, . . . have the same elements in common then each element D₁ D₂ . . . . belongs to D.

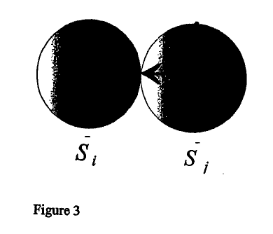

The j-th molecule of the chain is fitted to a conveniently shaped open bead Sj, with its center located at the center of the bead and its radius rᵢ has size such that the i-th bead does not overlap with the j-th bead when i≠j. In one embodiment, each segment may be treated as open beads such that coordinates belong to a set X and for any point p⊂dⱼ and δ=Dⱼ where the measure is positive so the definition of the bead is D={x: d(p,x)<δ}. The radiuses rᵢ, for example as illustrated in FIG. 3, are chosen so that the intersection of the closure of any two beads Si and Sj is a single point Pᵢⱼ. The point Pᵢⱼ, is the origin of a right and a left vector v_{iR}, v_{jL}. Mathematically, this may be described as follows: Let A and B be a disjoint convex sets in a convex space, then A={x:(x−Dᵢ)²<rᵢ} and B={x:x−Dⱼ)²<rⱼ}, so the distance is given by dis (Dᵢ,Dⱼ₎₌ᵣᵢ +rⱼ. The closure of B is given by B={x: (x−Dⱼ)^{2≦rj} then A∩B=θ.}

The set A is an open set by construction. Sets A and B are convex hull also by construction, then:

$$∃ l ( x ) = a if \begin{matrix}x ∈ A l ( x ) \leq a \\ x ∈ B l ( x ) \geq a\end{matrix}$$

where α is

$$\begin{matrix}{v}_{j} = {( a - {D}_{j} )}^{2} \\ {v}_{i} = {( a - {D}_{i} )}^{2}\end{matrix}$$

where Dᵢ=dist(a−v_{Ri}) and Dⱼ=dist(a−V_{Lj}). In one embodiment, these vectors are translated (projection) and rotated. The geometry of this construction may justify mathematically the bead construction.

For example, the simple arc length model may be expanded to address the finite volume occupied by each amino acid residue in a protein or peptide. While keeping the length and direction of the arc lengths constant, for example, a segment is expanded into a bead enveloping the remainder of its amino acid residue. In one embodiment, a residue comprises two beads. A bead interacts with at most two other beads, and the intersection of any two sequential beads is a single point. Therefore, the geometric structure of a protein may be defined by a braid.

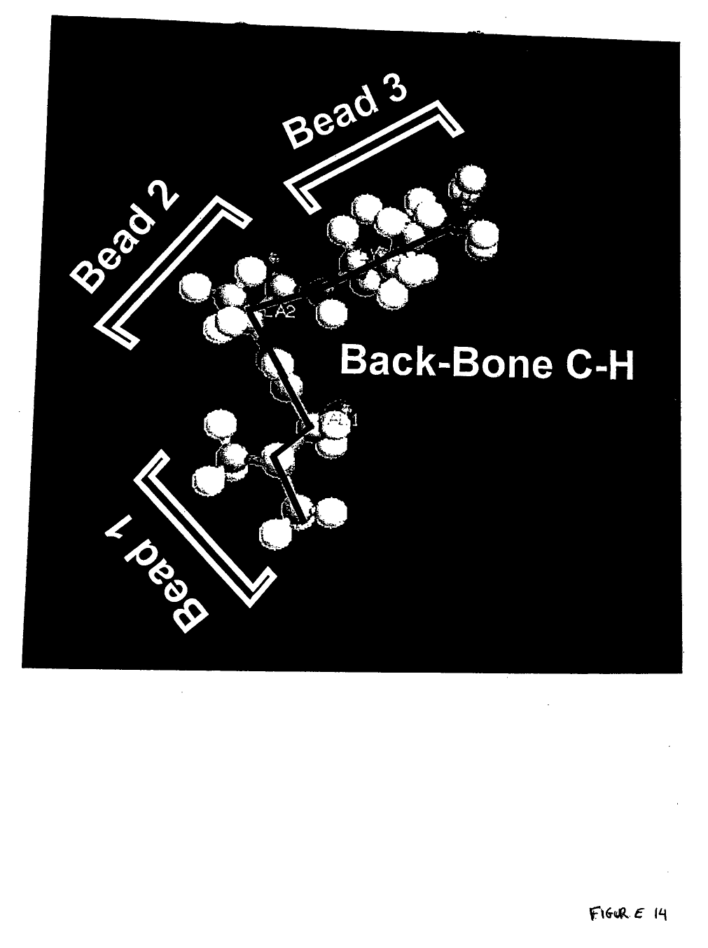

For example, the beads for a peptide formed from the amino acids Val-Ala-Lys, are shown in FIG. 14. Bead 1 includes valine and includes the carbonyl carbon of valine, but does not include the carbonyl carbon of alanine. Similarly, bead 2 includes alanine, and bead 3 includes lysine.

In one embodiment, a braid may represent a chain of molecules, for example, a peptide chain, which is a collection of beads, wherein the molecules may be beads. Conformations of the structure of the chain of molecules may be treated as changes in the relative orientation between pairs of beads. For large, single-chain proteins, for example, this may be a significantly simplified approach to molecular modeling.

The concept of a braid group may be described as follows. The definition of a braid is the union of the backbones creating a string representing the molecules, for example, amino acids. For a string of molecules, for example, which has three strands, (as group) or coils, for example, collagen and each strand has a back bone, represented as the union of all points x (ti−1,ti) that are generated:

$$Bonds = {⋃}_{n = 1}^{N} \{ x ( {t}_{i - 1} , {t}_{i} ) \} . \qquad ( 2.0 )$$

A braid is a collection of beads for which two operators (may be defined. The bead in the collection may be projected using a least squares method. Let B denote this collection of beads, so B={braids}, and(B,ₒ) is a group. The segments of the radius of bead of a single braid may then be checked for. The bead may shrink, driven by minimization. Mathematically, this may be described as: Let x ∈ S(r,x₀), S ∈ [symbol] ⁿand x₀≠0 i.e.

$$p ( x ) = {x}_{0} + r \frac{x}{‖ x ‖} , then ; r = ‖ p - {x}_{0} ‖ = ‖ {x}_{0} - r \frac{x}{‖ x ‖} - {x}_{0} ‖ = \frac{r}{‖ x ‖} ‖ x ‖ = r hence p ∈ S ( r , {x}_{0} ) .$$

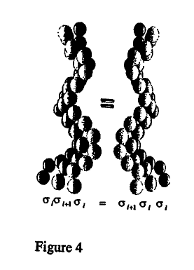

In one embodiment, one or more braids, strands or coils of a string of molecules may be modeled. For example, three coils may be modeled. For this example, the geometrical configuration may have an equivalence class denoted by σᵢ and σᵢ⁻¹ . A braid is equivalent and it is called isotope if the three coils cannot pass each other or themselves without intersecting (FIG. 4). The interaction of the equivalence classes may be described mathematically as σᵢσᵢ₊₁σᵢ=σᵢ₊₁σᵢσᵢ₊₁ if 1≦i≦n−2.

A protein structure composed of multiple peptides, for example, may be considered under this scheme, such as for example, a collagen triple helix. In this example, the collagen fibril is merely a three-stranded braid.

A chemical structure that comprises a string of molecules, for example a properly folded protein, may be in a minimum potential energy state. Here, the excluded volume of a chain of molecules may be used as a proxy for the free energy of the chain of molecules when bond angles and bond lengths are constrained to their standard, equilibrium values.

Given atom centers C1 and C2, torsional rotation of atom A about the C1—C2 bond may be modeled. Let the vector η₁ ∈ R³ defined as η₁:=C₁-C₂. Normalize η₁ to have length one and expand η₁ to and orthonormal basis B={η₁, η₂, η₃} of R³. Then the vector p ∈R³ as defined by p:=A−C₂ maybe written in the basis B as p=P₁η₁+p₂η₂+p₃η₃(3.1), where Pᵢηᵢ^{T}P. Since B is orthonormal (FIG. 4), the transform of the vector is:

η₁^{T}(p−p₁η₁)=η₁^{T}(p₁η₁+p₂η₂+p₃η₃)=0 (3.2).

The plane Q, with normal vector η₁ containing P₁η₁ also contains P. The vector p₁η₁ is the projection of P onto η₁. All points v ∈ R³ on the circle C in Q of radius p₁η₁ of radius r=∥p−p∥₂ containing P is of the form:

v(θ)=p₁η₁+(p₂cos(θ)+p₃sin(θ))η₂+(−p₂sin(θ)+p₃cos (θ))η₃ (3.3)

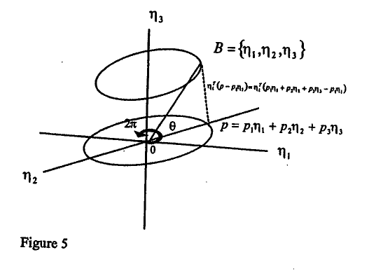

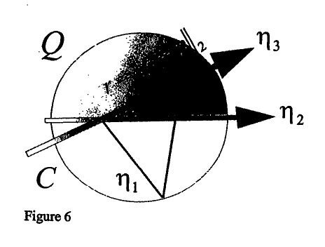

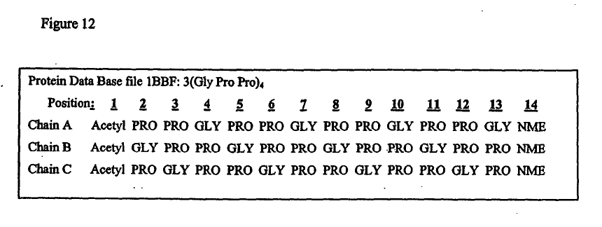

for some θ∈[0,2,π] (FIG. 5). The volume v may be in the form given in equation (3.3) so that v is in Q, and, given any θ in [0,2π), ∥v(θ)−p₁η₁∥₂∥₂=∥p₁η₁∥₂ since B is orthonormal, further v(0)=P (FIG. 6). For example, for a collagen triple helix, (FIG. 12) it may be assumed that the freedom of movement in 3[Gly-Pro-Pro]4 may only be due to torsional rotation about the Ca and the carbonyl carbon bond of each residue as well as the nitrogen and Cα bond in glycine.

This method may be significantly faster and may provide initial structures to facilitate the interpretation of, for example, protein NMR data. The structures estimated by this method may also be sufficient for studies of protein surface chemistries and protein-protein interactions.

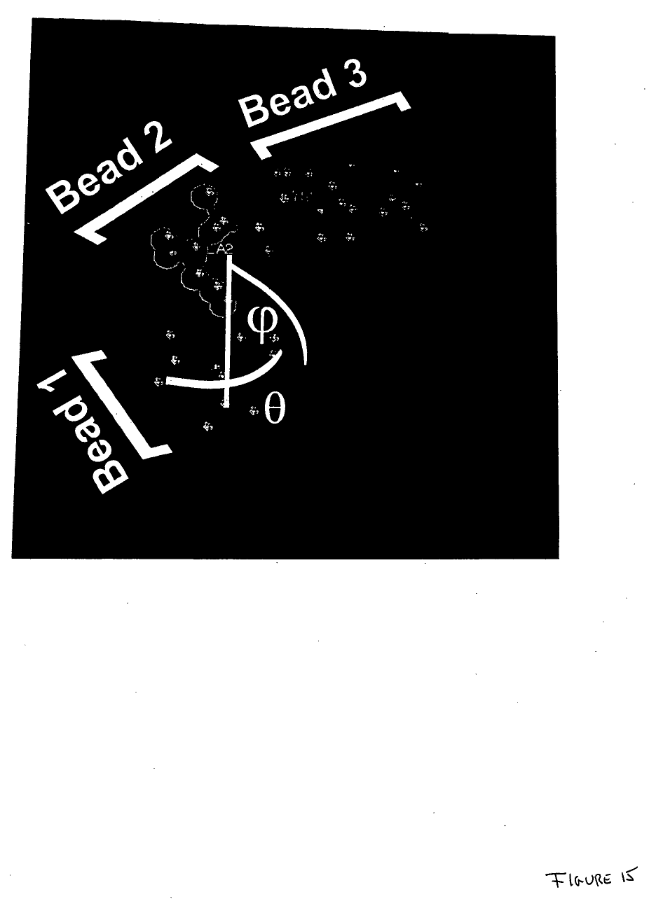

FIG. 15 shows the volume angle 0 and the dihedral angle (p of a bead for an exemplary peptide Val-Ala-Lys.

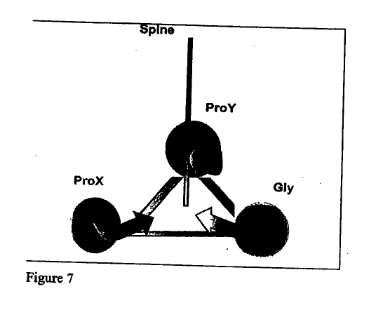

Another exemplary oligoepeptide 3[Gly-Pro-Pro]4 oligopeptide (accession number 1BBF in the Protein DataBase (PDB)), is shown in FIG. 7. A layer of three beads, which are shown by the arrows in FIG. 7, have a distance from the bead to the spine, after the first bead is locked into position. The distance from the CO=O(θ₂)−C(θ₂) to the center is given by the equation ∥b−r∥=0

The other two beads from the other two chains distances may then be calculated to that center. By calculating the distances from the bead to the spine, the distances are diminished. The spine limits how much the bead may be rotated. The spine is the norm in the plane of the bead and s stage norm can be based in the previous stages. With the spine, hydrophobic, hydrophilic, and other solvent related or dependent properties may be incorporated in the model. Since solvents may interact with the center of the molecular strand, for example the collagen strand, this interaction depends on amino acid properties, these properties may drive volume minimization.

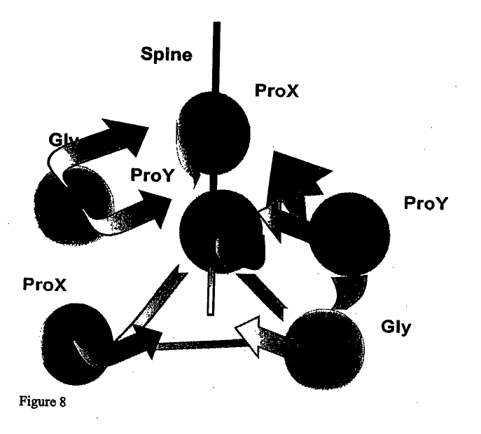

The next group of beads in the chain depend on the lock of the previous beads by that center and these beads may limited to that center (FIG. 8).

For exemplary purposes only, consider the bead involving the Van der Waals bond between ChainA-5-GLY and ChainB-3-PRO in a Type 1 collagen fragment. It may be supposed that the positions of the amide nitrogen and hydrogen of ChainA-5-GLY depend on the dihedral angle θ₁ and the carbonyl carbon and the carbonyl oxygen of ChainB-3-PRO depend on the dihedral angle θ₂. This defines a continuous mapping (θ₁, θ₂) [symbol] (N(θ₁), H(θ₁), O(θ₂), C(θ₂)) whose domain is the 2-cube [0,360]² and range is the position of these atom centers in conformational space. To volume minimize this bead, a set of dihedral angles (θ₁*, θ₂*) will be found such that the centers (N(θ₁), H(θ₁), O(θ₂) C(θ₂)) are “nearly” collinear and this order is preserved. The length of the vector CO=(θ₂)−C(θ₂) is independent of θ₂. The points may be “nearly” collinear when:

$$\begin{matrix}V ( {φ}_{1} , {φ}_{2} ) = {‖ H ( {φ}_{2} ) - C ( {φ}_{2} ) ‖}_{2}^{2} - \\ {( \frac{{( O ( {φ}_{2} ) - C ( {φ}_{2} ) )}^{T} ( H ( {φ}_{1} ) - C ( {φ}_{2} ) )}{{‖ CO ‖}_{2}} )}^{2} + \\ {‖ N ( {φ}_{2} ) - C ( {φ}_{2} ) ‖}_{2}^{2} - \\ {( \frac{{( O ( {φ}_{2} ) - C ( {φ}_{2} ) )}^{T} ( N ( {φ}_{1} ) - C ( {φ}_{2} ) )}{{‖ CO ‖}_{2}} )}^{2}\end{matrix} \qquad ( 5.0 )$$

is minimized over (θ₁, θ₂)∈[0,360]² The functional V is continuous over the compact set [0,360]² so that a minimizer (θ₁*, θ₂*) exists.

A necessary condition for the order to be preserved at a minimizer is that 1<t_{H(θ}_{₁}_{*)}<t_{N(θ}_{₁}_{*)} at the projections P_{H(θ}_{₁}_{*)}=L(t_{H(θ}_{₁}_{*)}, θ₂*) and P_{N(θ}_{₁}_{*)}=L(t_{N(θ}_{₁}*),θ₂*) and H(θ₁*) and N(θ₁*) onto the line L(t,θ₂)=C(θ₂)+t(O(θ₂)−C(θ₂)).

In an embodiment, distance geometry constraints may be included. Distance geometry constraints may include, for example, hydrogen bonding constraints, Van der Waal interaction contraints, covalent or ionic bonding constraints, and other constraints due to intramolecular and intermolecular forces or interactions. For example, for collagen oligopeptide (PDF accession number 1BBF), the O . . . H distances of 2.12 to 2.20 A° were found, and for the bonds were found to have the range from about 1.9 to about 3.0 A°. Using the constraint given by the relation 2.6≦∥O(θ₂)−H(θ₁)∥₂≦3.5, and the integrity of hydrogen bonds, equation (5.0) can then be utilized. These conditions uphold the physical strength of hydrogen bonding and the fact that two bodies may not occupy the same space at the same time.

To obtain a global minimizer, the following proposition may be used: Suppose the bead involves d dihedral angles. Let θ*=(θ₁*, . . . , θₙ*)∈[0,360]^{d} be an optimal solution to the constrained optimization problem:

$$δ = \frac{1}{2} {min}_{φ ∈ {[ 0 , 360 ]}^{d}} \{ v ( φ : φ \}$$

is a rotation about the bond i)}. There is then a maximal number n>0. The Pⁿ problem of an exhaustive search over the angles 0≦Φᵢ¹<. . . <Φᵢ^{P}≦360 to find an approximate optimizer \overline{Φ} to \overline{Φ}* may be difficult. There is exactly one solution to (5.0) in |\overline{Φᵢ}−p, \overline{Φᵢ} which would be Φ* and may be approximated using a given constrained optimization algorithm.

A constrained optimization algorithm may be used to find the solution to the constrained optimization problem, or the excluded volume of a bead. In one embodiment, the constrained optimization algorithm may be described as comprising:

1) Let Φ be the solution to Φ*=(Φ₁*, . . . , Φₙ*)∈[0,360]d and d dihedral angle, Φₙ*=Σ*→N, 1≦n≦k; Let q, r be polynomial such Φₙ*(I)≦q(|I|), where I is an instance of the angle. The instance construction system can be tested for a angles of the problem (TICA) and then P=NP.

2) Conversion: Where the dihedral angle Φ*=(Φ₁*, . . . , Φₙ*)∈[0,360]^{d} is the optimal solution, where d dihedral angles then

$$δ = \frac{1}{2} {min}_{φ ∈ {[ 0 , 360 ]}^{d}} \{ v ( φ : φ \}$$

is a rotation about the bond i)} n is maximum number of angles, n>0 and δ>0. Let ∈>0 be given. Where Φ* is continuous, there is a point

$$p ∈ {φ}^{*} , {φ}^{*} \leq \frac{1}{2} φ ( p )$$

where implies |\overline{Φᵢ}p,\overline{Φᵢ}+p|>∈ and

$$v ( p ) \leq \frac{1}{2} φ ( p ) ,$$

and then

$$\vert {\overline{φ}}_{i} - p , {\overline{φ}}_{i} + p \vert \leq {φ}^{*} + \vert v ( p ) \vert < δ + \frac{1}{2} φ ( p ) < ∈ .$$

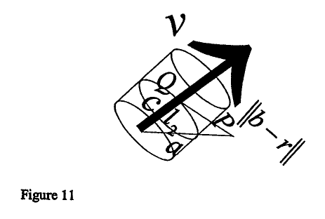

Using the existence and uniqueness theorem, Φ* is continuous, and in the interval |\overline{Φᵢ}−p, \overline{Φᵢ}+p| then converges, as shown in FIG. 11.

The convergence ball for the constrained optimization algorithm provides a candidate for p in the proposition. Using this proposition, an acceptable initial condition for a constrained optimization algorithm may be obtained.

In one embodiment, every stage, or every bead, is optimized individually via an equation analogous to equation 5.0 for a given chain of molecules. After obtaining the best optimization, the stages are coupled. To couple the stages or beads, they may need to be in the correct position. For example, the hydrogen bond is a group, and may include a homomorphism, for example, the stages may need to be close to collinear and bound every coil.

From the definition of a bead, there is at least there is one point in a single string which coincides with each bead in the string. For example, a stage may be a collection of three beads and the next stage may coincide with the previous one. In this example, the stage is matched to next stage by the three beads which form a plane. From that plane an orthonormal vector is obtained for the norm of the first set of beads forming the first stage. To obtain base a factorization algorithm may be used. In one embodiment, a QR factorization is used to form the basis.

The basis may be rotated into the beads to obtain a first norm N1. The same is done with the second group of beads for next stage to obtain the second norm N3. The norm of the norms N3 may then be found. The rotation is around the angles given by: cosθ=N1^{T} N2 sinθ=\sqrt{1−cos²θ}. The rotation is given by equation 3.3. After a first rotation, coincides may be checked for, where:

rotation=Q * v(θ)* Q^{t}*beads 6.0

The beads are from the first stage for the rotation. Matching the stages may comprise (using Mathlab notation, where “:” represents all rows):

Dist =RPT(:,1)′*RPT(:,1)−(bead2′*bead2) where RPT is the rotation and is the first column of the rotation matrix and the bead is the second from the second stage.

If after the rotation does not match a second rotation is needed. The angles where the rotation to occur may given by:

COSTHETA=(RPT(:,1)′*bead2)/(sqrt(RPT(:,1)′*RPT(:,1))*sqrt(bead′*bead))

SINTHETA=sqrt(1.0-COSTHETA*COSTHETA).

The next orthonormal vector is given by N2. The rotation may be obtained using equations 3.3 and 6.0. The norms may then be evaluated for alignment using:

RPT-[bead 2 from first stage, bead 1 from the second stage].

This model may be used for a orientations of chains of molecules. For example, for collagen or 310 helix the preference distance contains 3.0 residues per turn where 10 atoms in the ring formed by making the hydrogen bond three residues up the chain. The distance takes into consideration that the H bond lies parallel to the helix and that the carbonyl groups are pointing in one direction along the helix axis while N-H is in the opposite direction. The α-helix preference distance is given by nitrogen in one direction and the carbonyl opposite direction. Since the direction is measured from the carbonyl, the distance between turns is about 3.6 residues.

In one embodiment, a secondary structure may be modeled. In yet another embodiment, a globular protein or protein with an unknown secondary structure may be modeled by calculating in parallel, or simultaneously, the α-coil structure and the P-sheet structure and forming the braid as a union of the backbones of each structure. In an embodiment, other known algorithms may be used in combination with the present model. For example, computer algorithms such as Rosetta, CHARMM, or AMBER, may be used to first estimate, for example, the secondary structure of a protein, or for example, the atomic positions and bond lengths of a protein, and the instant model may be used to calculate, for example, the secondary and tertiary structure contributions.

For a protein with a secondary structure where the β-sheet orientation is symmetric, the β-sheets are measured from the nitrogen terminal to carbon terminal. The residue of the carbonyl and the nitrogen are in the same side. In the β-sheets inter-strand, the symmetric amide proton is the donor from the hydrogen bond to the carbonyl. Depending the orientation, the anti-parallel exchange is perpendicular and parallel is not. Parallel β-sheets may be more regular than anti-parallel β-sheets. The range of angles Φ and ψ angles for the peptide bonds, for example, in parallel sheets is comparatively much smaller than that for anti-parallel sheets. Parallel sheets are typically large structures. Anti-parallel sheets however consist of few strands. Parallel sheets characteristically distribute hydrophobic side chains on both sides of the sheet, while anti-parallel sheets are usually arranged with all their hydrophobic residues on one side of the sheet. This may involve an alteration of hydrophilic and hydrophobic residues in the primary structure of peptides involved in anti-parallel P-sheets because alternate side chains project to the same side of the sheet.

In some embodiments for example, collagen, the N—H and the C═O (each with an individual dipole moment) may need to be in the same plane to create a large net dipole for the structure whether it is α, ° or 310.

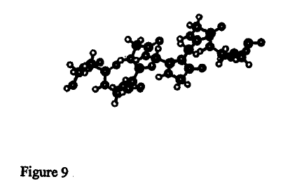

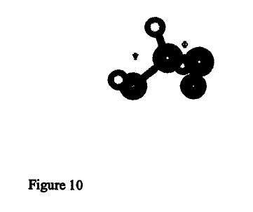

In one embodiment the tertiary structure of a chain of molecules is determined. In another embodiment, protein structure with the surface folded is determined. For example, a protein may be thought of as a backbone with additional groups attached to it. This backbone may not be straight as the bonds are in general not collinear, for example bonds on a carbon atom will tend to form tetrahedral rather than straight chains. The groups, with an outline of the atoms centered on the backbone atom, creates a strings of beads (though the bead shape may not be round or spherical), and the lacing of the beads is the backbone of the protein (FIG. 9). The amino acids have bonds that may rotate. In one embodiment, there may be 2 bonds that rotate (FIG. 10).

The R groups of each amino acid may comprise one, two, or more of various groups, atoms, molecules or physical parameters. In the case of, for example, proline there is only one free rotating bond, and it may also attach to a hydrogen. This situation may be considered by a mathematical constraint or function, for example, an error function, that employs a corresponding penalty to the optimization function.

A molecule that can be twisted to any shape may now be modeled. In one embodiment, the shape of the beads may be further minimized or selected by the use of an optimization function for minimization in the process. In an embodiment, the optimization function may closely mirror an energy function, in that the lower the function the better. In one embodiment, the optimization function may include parameters that reflect an aqueous environment around or in the chain of molecules being modeled, pH effects, temperature effects, parameters which reflect polar and non-polar molecular behavior, intermolecular interactions, intramolecular interactions, Van der Waals interactions, solvent effects, packing defects, solvation, solubility effects, and cavities in one or more of the molecules.

In one embodiment, the optimization function may have the form:

E=volume(volumeweighing)−Σsurfacearea₁₂hydrophicity₁ hydrophicily₂.

The surface area is of a residue, which may have a hydrophicity. The volume weighs are proportional to the amount of energy to move a R group from cyclohexane to water (0 is neutral, −1 is hydrophilic and 1 is hydrophobic). The surface of the whole amino acid or molecules, rather than just the R group, may be used.

The surface may be calculated from the intersection of the surfaces, or the atomic radii of the atoms in the residue. The summation may be over a set of residues that are touching and/or next to each other. The surface area is the common surface are between the residues. This term will tend to have hydrophobic residues together and hydrophilic together, but may avoid having hydrophilic next to hydrophobic.

There may also be a volume term that minimizes the size of the molecule. This volume may be given as the volume enclosed by the surface wetted by a solvent molecule several angstroms in radius. The angles that are adjusted change the configuration but may not change the angles themselves. A method of modeling a chain of molecules may comprise starting the process with a molecule in the chain, for example first, last, and/or one in the middle. A molecule linked to another, may be treated or optimized in combination as a unit, for example two molecules may be treated as one; the larger unit having 2 bond angles (one in front and one in back) creating a chain with large units. A computer or processor could start from the first molecule; and the two chains, produced by the two programs, may then be combined for a complete molecule.

The optimization used here is may be called a simplex search, or a configurational minimization, and can be compared to an ameba that searches the solution space to optimize the equation. This method is highly parallel (similar to a Monte Carlo sampling) in that each sample of the solution space is independent, and can be parallelizable.

In one embodiment, a bond may almost always stay at the optimal angle. Generally bonds are considered to be of fixed length (only rotation may be allowed). The rotation of non-collinear bonds allows the molecule to twist, (e.g. similar to some of the rubix toys where a set of angles are joined by rotating joints), to allow the molecule to have a shape. In one embodiment, the algorithm or process for optimizing the molecule shape may comprise:

Selecting a molecule in the chain. If there are multiple chains, selecting a set of matching molecules. This gives 6 rotation angles.

Selecting a set of angles (this is in 6-d space each dimension going from 0-360 degrees) using a simplex optimizer to select the set of angles that optimize the function, with the limitation that the molecules may not have bond distances (between themselves) of less than normal bond lengths.

Selecting the next set of molecules that are attached to the current set (this gives another 6 angles) repeat above.

In one embodiment, the algorithm may be used to calculate the shape of a peptide or protein, which may be a chain of amino acids. In an embodiment, the algorithm for optimization of the protein shape may comprise:

1) Selecting an amino acid, for example, the end of the chain. If there are multiple chains, selecting a set of matching amino acids (in the case of collagen pick the 3 end amino acids, one for each chain). This gives 6 rotation angles.

2) Selecting a set of angles (this is in 6-d space, a dimension ranging from 0-360 degrees) using a simplex optimizer to select the set of angles that optimize the function, with the limitation that the molecules may not have bond distances (between themselves) of less than normal bond lengths.

3) Selecting a next set of amino acids that are attached to the current set (this gives another 6 angles) and returning to 2).

In an embodiment, the method further comprises known molecular modeling algorithms and software, such as CHARMM, AMBER, and QUANTA.

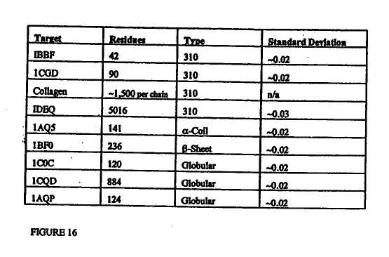

FIG. 16 shows the standard deviation of the calculated tertiary structure for nine exemplary proteins in comparison with the known tertiary structure from the Protein Data Bank.

4. Functional Properties of Molecules

A method is provided for identifying molecules which interact with a target protein, the method comprising determining a minimum excluded volume of an amino acid in said target protein, determining a lowest free energy or potential of said protein complexed to a small molecule selected from a library of small molecules, repeating the steps to identify the small molecule that provides the lowest free energy of said complex, and selecting the small molecule that provides the lowest free energy.

In an embodiment, the method further comprises determining the identity of a domain of a protein which may be responsible for the protein's ability to bind a chosen target. The initial potential binding domain may be: 1) a domain of a naturally occurring protein, 2) a non-naturally occurring domain which substantially corresponds in sequence to a naturally occurring domain, but which differs from it in sequence by one or more substitutions, insertions or deletions, 3) a domain substantially corresponding in sequence to a hybrid of subsequences of two or more naturally occurring proteins, or 4) an artificial domain designed entirely on theoretical grounds based on knowledge of amino acid geometries and statistical evidence of secondary structure preferences of amino acids. The domain may be a known binding domain, or at least a homologue thereof, but it may be derived from a protein which, while not possessing a known binding activity, possesses a secondary or higher structure that lends itself to binding activity (clefts, grooves, etc.).

In one embodiment, the method comprises a process or algorithm which estimates the binding potential of atoms to or near a protein. In one embodiment, the binding site or domain may be at internal or external surfaces of the protein. For example, algorithms or processes which determine the Gibbs free energy of binding, type of ligand, binding affinity, size, geometry and three-dimensional models of the ligand or target may be used, such as, for example, the Woolford algorithm. Other algorithms which may be used in docking programs such as GRAM, DOCK or AUTODOCK.

In one embodiment, the method comprises identifying regions of proteins that have a low structural stability. In another embodiment, the method comprises identification of regions of a protein that has a probability of being populated by a ligand.

In an embodiment, the method may further comprise producing models of proteins with an unknown function. Using these models, databases of protein structures with known function are then searched for structural similarity. From this similarity, the unknown proteins functions may be inferred.

In an embodiment, the method may further comprise detection of DNA-protein interactions.

5. Computer Products and Systems

A computer product can determine the structure of a chain of molecules, where the computer product is disposed on a computer readable medium, such as an external or internal storage device, and the computer product includes instructions to cause at least one processor to minimize the volume of molecular units in the chain of molecules. In one embodiment, the computer product determines the structure of a protein, wherein the instructions cause a processor to minimize the volume of amino acids in a polypeptide chain.

A system for the disclosed methods thus can include a processor and instructions for causing the processor to minimize the volume of amino acids in a polypeptide chain. In one embodiment, the instructions cause the processor to minimize the volume of amino acids in a polypeptide chain.

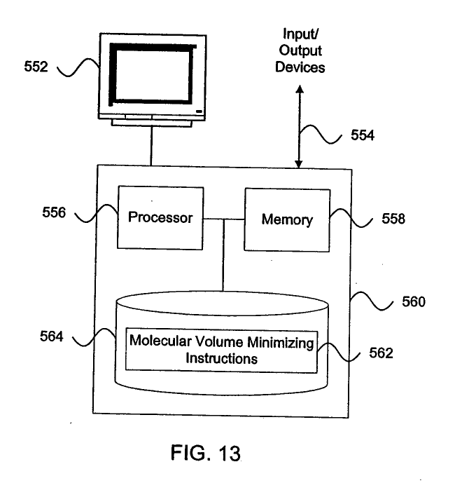

FIG. 13 illustrates a computer or processor platform 560, suitable for executing instructions 562, implementing techniques described above. The platform 560 includes a processor 556, volatile memory 558, and non-volatile memory 564. The instructions 562 are transferred, in the course of operation, from the nonvolatile memory 562 to the volatile memory 558 and processor 556 for execution. The platform 560 may communicate with a user via a monitor 552 or other input/output device 554 such as a keyboard, mouse, microphone, and so forth. Additionally, the platform 560 may feature a network connection, for example, to distribute processing over many different platforms.

The methods and systems described herein are not limited to a particular hardware or software configuration, and may find applicability in many computing or processing/processor environments. The methods and systems can be implemented in hardware or software, or a combination of hardware and software. The methods and systems can be implemented in one or more computer programs or instructions sets executing on one or more programmable computers or other devices that include a processor, a storage medium readable by the processor (including volatile and non-volatile memory and/or storage elements), one or more input devices, and one or more output devices.

Although the illustrated processor can be associated with a personal computer (PC), those with ordinary skill in the art will recognize that the processor can be one or more processors that can be communicatively connected via a wired or wireless network. It is not necessary that the processor be resident on a PC, and other processor-controlled devices can be used, including but not limited to servers, workstations, telephones, personal digital assistants (PDAs), and other devices that include a processor and instructions for causing the processor to perform according to the disclosed methods and systems.

The processor instructions can be implemented in a high level procedural, object oriented programming language, assembly language, and/or machine language. The language(s) can be a compiled or interpreted language.

The processor instructions can be stored on one or more storage media or devices that include, for example, Random Access Memory (RAM), Read Only Memory (ROM), floppy disks, CD-ROM, DVD, external or internal hard drives, magnetic disks, optical disks, Redundant Array of Independent Disks (RAID), and other storage systems or devices that can be read and accessed by a processor for allowing the processor to perform based on the disclosed methods and systems.

Exemplification

The invention now being generally described, it will be more readily understood by reference to the following examples, which are included merely for purposes of illustration of certain aspects and embodiments of the present invention, and are not intended to limit the invention.

### EXAMPLE 1

Accession number IBBF (PDB)

An important subgroup of proteins are constituents of the extracellular matrix (ECM). Collagen represents a family of extracellular matrix (ECM) proteins accounting for one third of the body's protein and occurring in essentially all tissues. These proteins form supramolecular ECM structures serving as the primary structural component of most tissues. Collagen type I is the most abundant type with widespread distribution in dermis, bone, ligament and tendon providing strength, flexibility, movement, and carries tension and where appropriate resists compression stresses. These material properties are due to the basic structural triple-helix configuration of collagen as deduced from high angle X-ray diffraction studies. Collagen molecules form a left-handed superhelix by electrostatic forces that are staggered by one residue relative to each molecule. This helical structure is possible due to every third amino acid being a glycine residue, permitting close packing along the central axis and hydrogen bonding between protein chains.

Collagen has a secondary structure wherein the P-sheet orientation is symmetric. The β-sheets are measured from the nitrogen terminal to carbon terminal. The residue of the carbonyl and the nitrogen are in the same side. In the β-sheets inter-strand, the symmetric amide proton is the donor from the hydrogen bond to the carbonyl. Depending the orientation, the anti-parallel exchange is perpendicular and parallel is not. The distance between residues for this example is about 0.347 nm for anti-parallel and about 0.325 nm for parallel pleated sheet. Parallel β-sheets may be more regular than anti-parallel β-sheets.

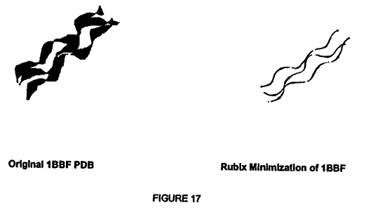

These collagen molecules have the accession number IBBF in the Protein DataBase (PDB). Comparison of the calculated structure of IBBF using the minimization model disclosed herein, to the PDB crystal structure is shown in FIG. 17. As can be seen from FIGS. 16 and 17, the tertiary structure predicted using the minimization model has a standard deviation of about 0.02 from the known tertiary structure of collagen. Similar results were obtained with other proteins as described in the following examples:

### EXAMPLE 2

Accession Number 1CGD (PDB):

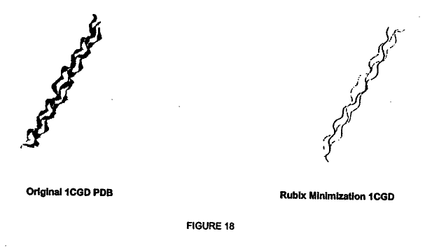

Hydration structure of a collagen peptide; (Pro-Hyp-Gly)4 Pro-Hyp-Ala (Pro-Hyp-Gly)5. Comparison of the calculated structure using the rubix minimization model, of ICGD to the PDB crystal structure is shown in FIG. 18.

### EXAMPLE 3

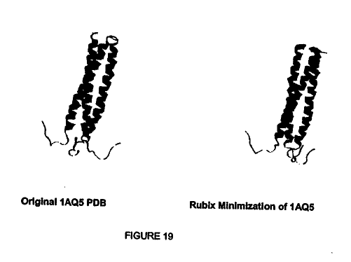

Accession IAQ5 (PDB): Trimeric Coiled-Coil Domain of Chicken Cartilage Matrix Protein. Comparison of the calculated structure of 1AQ5 to the PDB crystal structure is shown in FIG. 19.

### EXAMPLE 4

Accession IDEQ (PDB): Modified Bovine Fibrinogen

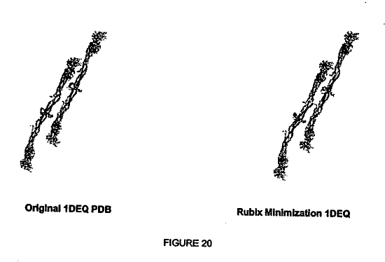

Comparison of the calculated structure of 1DEQ to the PDB crystal structure is shown in FIG. 20.

### Example 5

Association 1COC (PDB): Bovine Pancreatic Ribonuclease A

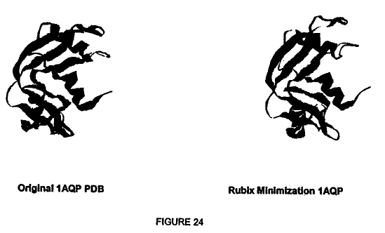

Comparison of the calculated structure of 1 COC to the PDB crystal structure is shown in FIG. 24.

### Example 6

Association 1AQP: Ribonuclease A Copper Complex

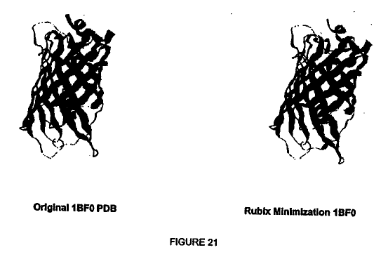

Comparison of the calculated structure of LAQP to the PDB crystal structure is shown in FIG. 21.

### Example 7

Association 1BFO: Calcicludine (Cac) From Green Mamba Dendroaspis Angusticeps

Comparison of the calculated structure of 1BFO to the PDB structure is shown in FIG. 21.

### Example 8

Association 1 CQD Cysteine Protease With Proline Specificity From Ginger Rhizome, Zingiber Officinale.

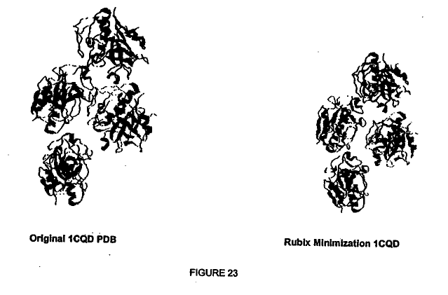

Comparison of the calculated structure of 1 CQD to the PDB structure is shown in FIG. 23.

Equivalents

While specific embodiments have been discussed, the above specification is illustrative and not restrictive. Many variations will become apparent to those skilled in the art upon review of this specification. The full scope of the disclosure should be determined by reference to the claims, along with their full scope of equivalents, and the specification, along with such variations.

Unless otherwise indicated, all numbers expressing quantities of conditions, parameters, descriptive features and so forth used in the specification and claims are to be understood as being modified in all instances by the term “about.” Accordingly, unless indicated to the contrary, the numerical parameters set forth in this specification and attached claims are approximations that may vary depending upon the desired methods and systems disclosed herein.

### REFERENCES

All publications and patents mentioned herein, are hereby incorporated by reference in their entirety as if each individual publication or patent was specifically and individually indicated to be incorporated by reference. In case of conflict, the present application, including any definitions herein, will control.

We claim:

1. A method for determining the tertiary structure of a protein comprising:
providing a protein having a known primary structure; and
determining the minimum excluded volume of said protein.

2. A method for determining a structure of a protein comprising determining a minimum excluded volume of at least two amino acids in said protein.

3. The method of claim 2, further comprising selecting one or more angles which minimize said excluded volume of said at least one amino acid.

4. The method of claim 3, wherein said angle is selected from the group consisting of dihedral angles or torsional angles.

5. The method of claim 2, further comprising sequentially:
i) selecting one of said two amino acids; and
ii) determining an angle which minimizes the volume of the selected amino acid;
wherein the volume comprises the R group of the selected amino acid.

6. The method of claim 5, wherein (i) and (ii) are performed iteratively.

7. The method of claim 5, wherein iterative selection comprises selecting an amino acid that is attached to the selected amino acid of a previous iteration.

8. The method of claim 7, comprising further determining a minimum excluded volume of both amino acids.

9. The method of claim 5, wherein said angle is determined by determining a difference between a distance of:
atoms of a first amino acid and atoms of a distinct second amino acid; and
a projection onto a plane of atoms of said first amino acid and atoms of said distinct second amino acid.

10. The method of claim 2, wherein said protein comprises a single-chain protein.

11. The method of claim 2, wherein said protein comprises multiple-chain peptides.

12. The method of claim 2, wherein further bond angles and bond lengths between said two amino acids are constrained to an equilibrium value.

13. The method of claim 5, wherein determining a minimum further includes providing distance constraints between hydrogen atoms and oxygen atoms on said two amino acids.

14. The method of claim 2, further comprising minimizing the volume of each amino acid by using an optimization function.

15. The method of claim 14, wherein said optimization function comprises the hydrophicity of said amino acid.

16. A method for identifying molecules which interact with a target protein comprising:
(a) determining the minimum excluded volume of each amino acid in said target protein;
(b) determining the lowest free energy of said protein complexed to a small molecule selected from a library of small molecules;
(c) repeating (b) to identify the small molecule that provides the lowest free energy of said complex; and
selecting the small molecule that provides the lowest free energy.

17. The method of claim 16, wherein said target protein is an enzyme.

18. The method of claim 16, wherein said target protein is a receptor.

19. A method for rational drug design comprising:
providing a protein having a known ligand binding site; and
determining a minimum excluded volume of said ligand binding site;
determining a lowest potential energy of said ligand binding site complexed to a small molecule selected from a library of small molecules;
identifying the small molecule that provides the lowest free energy of said complex; and
selecting the small molecule that provides the lowest free energy.

20. A method for determining a structure of a protein comprising:
i) representing one or more polypeptide sequences using a series of constant arclengths;
ii) selecting an angle which minimizes the volume around one arclength;
iii) selecting an angle which minimizes the volume around an arclength associated with the arc length in ii);
iv) iterating ii) and iii) along a polypeptide chain.

21. The method of claim 20, wherein said arc length is determined from an atom in one amino acid, to an atom in a distinct second amino acid.

22. A computer product for determining the structure of a protein, the product disposed on a computer readable medium, and including instructions a causing a processor to: minimize the volume of amino acids in a polypeptide chain.

23. A system comprising a processor and instructions for causing a processor to minimize the volume of amino acids in a polypeptide chain.
